(19) United States
(12) Patent Application Publication
(10) Pub. No.: US 2018/0159103 A1
(43) Pub. Date: Jun. 7, 2018

(54) SECONDARY BATTERY, AND METHOD OF MANUFACTURING SECONDARY BATTERY

(71) Applicant: HITACHI, LTD., Tokyo (JP)

(72) Inventors: Kazuaki NAOE, Tokyo (JP); Yusuke KAGA, Tokyo (JP); Shimpei AMASAKI, Tokyo (JP); Makoto ABE, Tokyo (JP); Etsuko NISHIMURA, Tokyo (JP); Akihiko NOIE, Tokyo (JP)

(73) Assignee: HITACHI, LTD., Tokyo (JP)

(21) Appl. No.: 15/831,527

(22) Filed: Dec. 5, 2017

(30) Foreign Application Priority Data
Dec. 6, 2016 (JP) 2016-236524

(51) Int. Cl. H01M 2/16; H01M 10/0569; H01M 10/0525; H01M 10/0568; H01M 10/0585

(52) U.S. Cl. CPC H01M 2/166; H01M 10/0569; H01M 10/0525; H01M 10/0585; H01M 2/1646; H01M 2/1673; H01M 2/1653; H01M 10/0568

(57) ABSTRACT

Provided is a secondary battery having better performance. The secondary battery includes: a negative electrode; a positive electrode; an insulating layer; and a structure having pores each configured to carry an electrolyte, in which: the negative electrode and the positive electrode are alternately laminated on each other through intermediation of the insulating layer; and the structure is arranged in a region which is sandwiched between two of the insulating layers and faces at least part of an edge of the positive electrode, and includes a material different from a material of the insulating layer.

### CLAIM OF PRIORITY

This application claims the priority based on the Japanese Patent Application No. 2016-236524 filed on Dec. 12, 2016. The entire contents of which are incorporated herein by reference for all purpose.

### BACKGROUND OF THE INVENTION

The present invention relates to a secondary battery and a method of manufacturing a secondary battery.

A technology related to an electrode body is disclosed in Japanese Patent Laid-open Publication No. 2016-119183. In paragraph [0019] of the literature, there is a description of “The insulating layers 13 and 15 are formed on the positive electrode mixture layer 12 (the first region 31) and on the second region 32 on the positive electrode collector 11 so as to cover the positive electrode mixture layer 12. Herein, the second region 32 is a region adjacent to the first region 31 in a width direction.” In addition, in paragraph [0024] of the literature, there is a description of “In this case, in the electrode body 1 according to this embodiment, the resin particles of the insulating layer 15 formed on the second region 32 on the positive electrode collector 11 are thermally fused to each other.” In addition, in paragraph [0026], there is a description of “When the resin particles are thermally fused to each other (that is, the resin particles are formed into a film) as described above, the adhesion strength between the resin particles can be increased, and the strength of the insulating layer 15 can be increased. Therefore, a situation in which a burr generated through cutting of the negative electrode sheet 20 (that is, a burr generated at the end portion 25 of the negative electrode collector 21) breaks through the insulating layer 15 to form a short circuit between the positive electrode 10 and the negative electrode 20 can be prevented.”

A secondary battery is formed by laminating a positive electrode and a negative electrode on each other through intermediation of an insulating layer allowing ions to pass therethrough and having an insulating property. At this time, the electrodes are formed in different sizes in some cases, as illustrated in, for example, the drawings of Japanese Patent Laid-open Publication No. 2016-119183.

As described in the literature, when the insulating layer is arranged to have a larger size than the smaller electrode in the case in which the insulating layer is formed through use of a skeleton material, such as resin particles, a load may be concentrated at an end portion of the smaller electrode at the time of lamination to cause lack of the insulating layer brought into contact with the vicinity of the end portion. In addition, an electrolyte in the insulating layer seeps out at the time of lamination to cause a reduction in battery performance.

### SUMMARY OF THE INVENTION

The present invention has been made in view of the foregoing, and an object of the present invention is to provide a secondary battery having better performance.

This application includes a plurality of means for solving at least part of the above-mentioned problem, and an example of the plurality of means is as follows.

In order to achieve the above-mentioned object, according to one embodiment of the present invention, there is provided a secondary battery, including: a negative electrode; a positive electrode; an insulating layer; and a structure having pores each configured to carry an electrolyte, in which: the negative electrode and the positive electrode are alternately laminated on each other through intermediation of the insulating layer; and the structure is arranged in a region which is sandwiched between two of the insulating layers and faces at least part of an edge of the positive electrode, and includes a material different from a material of the insulating layer.

According to the present invention, the secondary battery having better performance can be provided.

Objects, configurations, and effects other than those described above become more apparent from the following descriptions of embodiments.

### BRIEF DESCRIPTION OF THE DRAWINGS

FIG. 1 is a schematic plan view for illustrating an example of a secondary battery according to one embodiment of the present invention.

FIG. 2A and FIG. 2B are each a schematic view for illustrating an example of a sectional surface of the secondary battery according to the embodiment.

FIG. 3A and FIG. 3B are views for illustrating arrangement positions of structures in Example and Comparative Example.

FIG. 4 is a view for illustrating positions subjected to analysis of a weight ratio (S/Si) of sulfur to silicon.

FIG. 5 is a sectional view of a laminate for illustrating lack of an insulating layer.

### DESCRIPTION OF THE PREFERRED EMBODIMENTS

Now, an example of an embodiment of the present invention is described with reference to the drawings. When the count of pieces of a component or the like (including the count, numerical value, amount, and range of a component) is mentioned in the following embodiment, the present invention is not limited to the particular count mentioned and the component count may be higher or lower than the particular count, unless explicitly noted otherwise or unless it is theoretically obvious that the component count is limited to the particular count. Further, it should be understood that, in the following embodiment, a component (including a constituent step) is not always indispensable unless explicitly noted otherwise or unless it is theoretically obvious that the component is indispensable.

Similarly, when the shapes, positional relations, and the like of components are mentioned in the following embodiment, shapes and the like that are substantially approximate to or similar to the ones mentioned are included unless explicitly noted otherwise or unless it is theoretically obvious that it is not the case. The same applies to the numerical value and the range. In addition, the same members are denoted by the same reference symbol in principle in all the drawings for illustrating the embodiment, and repetitious descriptions for such members are omitted. Hatching may be performed even in a plan view so that the drawing is clearly shown.

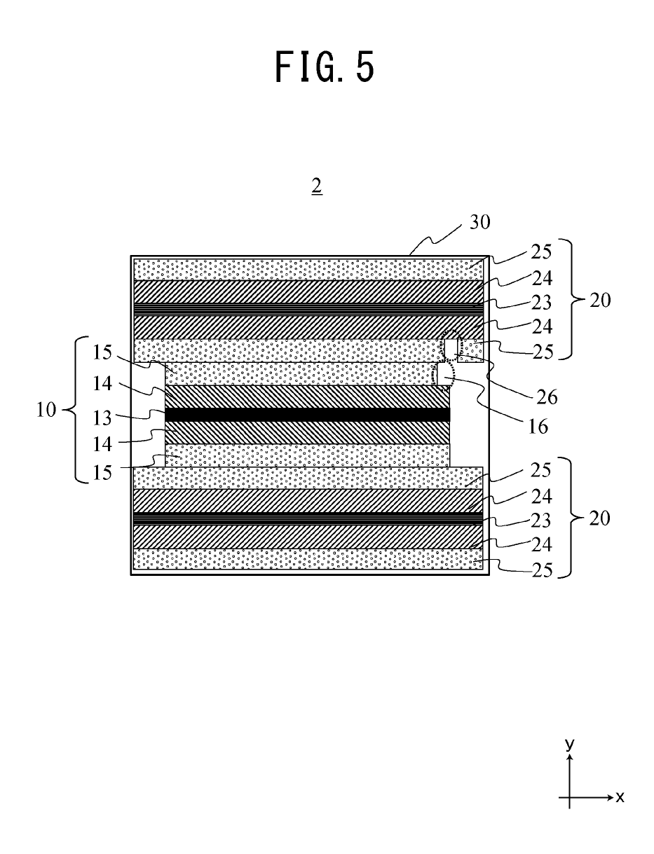

FIG. 5 is a sectional view of a secondary battery 2 for illustrating lack of an insulating layer. The secondary battery 2 includes: a laminate in which a positive electrode 10 and a negative electrode 20 are alternately laminated on each other; and an exterior body 30. Now, a description is given using an example in which the secondary battery 2 is a lithium ion battery. In addition, the description is given using the x direction of FIG. 5 and the z direction described later as in-plane directions, and using the y direction of FIG. 5 perpendicular to the in-plane directions as a lamination direction.

In a lithium ion secondary battery, lithium ions moved from the positive electrode 10 precipitate at a portion other than the negative electrode 20 to reduce a discharge capacity in some cases. In order to prevent such situation, as illustrated in FIG. 5, the laminate is formed so that the negative electrode 20 is larger than the positive electrode 10 in the in-plane directions. That is, a step is generated between the positive electrode 10 and the negative electrode 20.

The positive electrode 10 and the negative electrode 20 are laminated on each other through intermediation of an insulating layer. Now, the description is given using an example in which the positive electrode 10 and the negative electrode 20 each have laminated thereon an insulating layer. A positive electrode electrolyte layer 15 is laminated on the positive electrode 10 as an insulating layer. Similarly, a negative electrode electrolyte layer 25 is laminated on the negative electrode 20 as an insulating layer. The insulating layer may be laminated only on the negative electrode 20.

In addition, in recent years, a technology involving using an electrolyte in a semi-solid state (including a gel form, a solid state, and a quasi-solid state) for a secondary battery has attracted attention. In such case, the insulating layer is formed by causing a skeleton material, such as fine particles, to carry an electrolytic solution so that the insulating layer functions as an electrolyte layer.

When the secondary battery is formed through use of the semi-solid electrolyte, a method of tightly binding the laminate is adopted in some cases for the purpose of, in each electrode, reducing an interfacial resistance between an electrode active material and the electrolyte layer (i.e., insulating layer) so that lithium ions are smoothly delivered between the electrode active material and the electrolyte. The tightly binding refers to applying a load from an outside of the laminate in the lamination direction. That is, a load is applied to the laminate illustrated in FIG. 5 in the −y direction from an upper surface of the laminate and in the +y direction from a lower surface of the laminate.

Through the tight binding, the load is concentrated in the vicinity of an end portion of the positive electrode 10, resulting in lack of the insulating layer in the vicinity of the end portion of the positive electrode 10. In FIG. 5, a laminate in which a missing portion 16 is generated at an end portion of the positive electrode electrolyte layer 15 and a missing portion 26 is generated at a portion of the negative electrode electrolyte layer 25 facing the end portion of the positive electrode 10 is illustrated. The generation of the missing portions 16 and 26 causes exposure of the electrodes, and a short circuit therebetween.

In addition, the electrolyte in a semi-solid state has a structure in which a skeleton material, which is an insulating solid having a large specific surface area, such as fine particles, carries an electrolytic solution. In this case, pressurization through the tight binding or pressurization in association with expansion of the electrodes allows the electrolytic solution to seep out from the electrolyte, resulting in a reduction in battery performance.

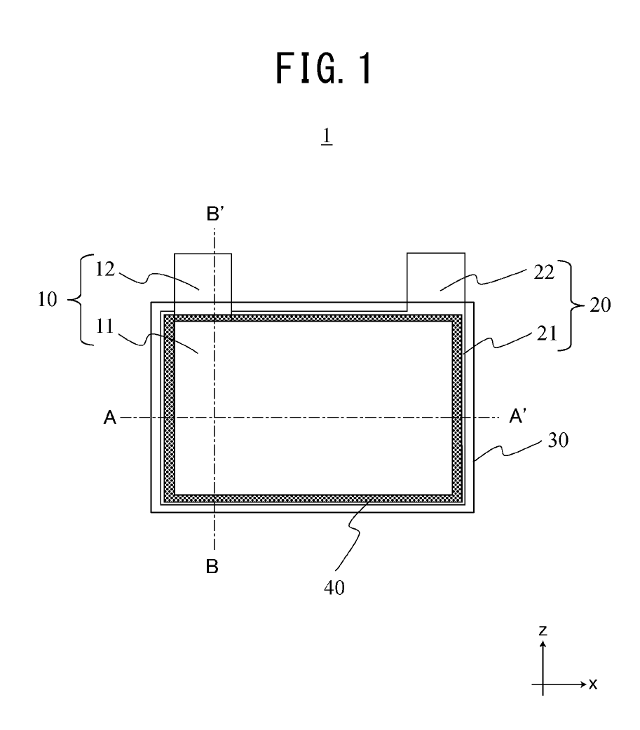

FIG. 1 is a schematic plan view for illustrating an example of a secondary battery 1 according to one embodiment of the present invention. The secondary battery 1 includes a positive electrode 10, a negative electrode 20, an exterior body 30, and a structure 40.

The positive electrode 10 has a substantially rectangular shape, and includes a positive electrode laminate portion 11 and a positive electrode terminal portion 12. The positive electrode laminate portion 11 has a configuration in which a positive electrode mixture layer 14 and a positive electrode electrolyte layer 15 are laminated on a positive electrode collector foil 13, and the details thereof are described later. The positive electrode terminal portion 12 is obtained by extending the positive electrode collector foil 13 of the positive electrode laminate portion 11 to an outside of the exterior body 30, and may be connected to an external power source.

The negative electrode 20 has a substantially rectangular shape, and includes a negative electrode laminate portion 21 and a negative electrode terminal portion 22. The negative electrode laminate portion 21 has a configuration in which a negative electrode mixture layer 24 and a negative electrode electrolyte layer 25 are laminated on a negative electrode collector foil 23, and the details thereof are described later. The negative electrode terminal portion 22 is obtained by extending the negative electrode collector foil 23 of the negative electrode laminate portion 21 to an outside of the exterior body 30, and may be connected to an external power source. The exterior body 30 serves as a cover for the laminate, and its size, material, and the like are not limited.

The structure 40 is arranged in a region facing at least part of four side edges of the positive electrode 10. The structure 40 illustrated in FIG. 1 is arranged in regions facing the four side edges of the positive electrode 10. The structure 40 may be arranged so as to protrude from the negative electrode 20 in the x direction or the z direction (in-plane direction) of FIG. 1. However, in consideration of the energy density of the secondary battery 1, it is desired to arrange the structure 40 within a range of the negative electrode 20 so that the volume of the laminate is reduced more.

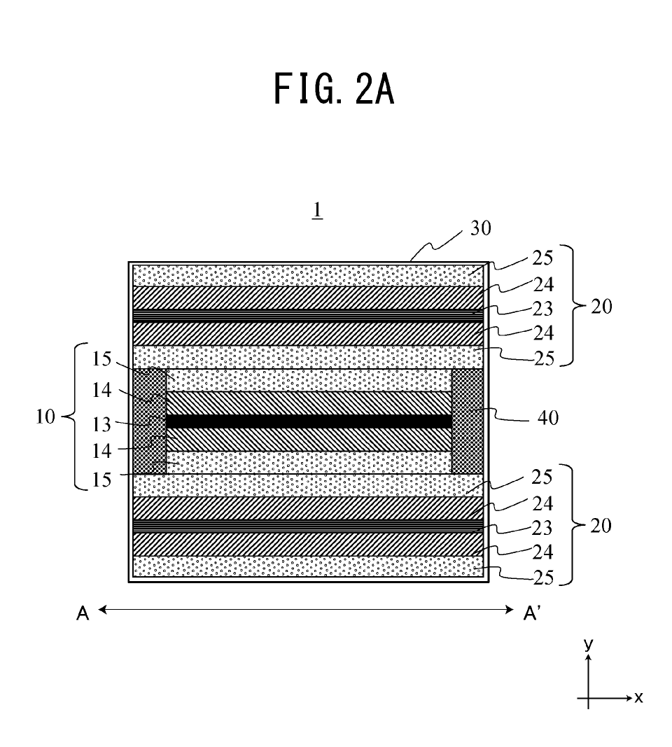

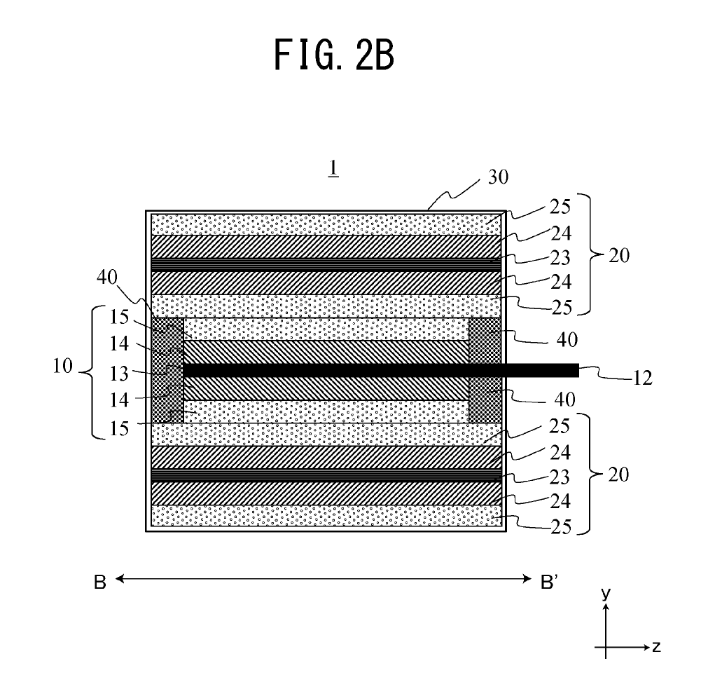

FIG. 2 are each a schematic view for illustrating an example of a sectional surface of the secondary battery 1 according to this embodiment. FIG. 2A is a sectional view of the secondary battery 1 of FIG. 1 taken along the plane A-A′, and FIG. 2B is a sectional view of the secondary battery 1 of FIG. 1 taken along the plane B-B′.

The positive electrode 10 includes the positive electrode collector foil 13, the positive electrode mixture layer 14, and the positive electrode electrolyte layer 15. In addition, the negative electrode 20 includes the negative electrode collector foil 23, the negative electrode mixture layer 24, and the negative electrode electrolyte layer 25. The positive electrode 10 and the negative electrode 20 are alternately laminated on each other through intermediation of an insulating layer (at least one of the positive electrode electrolyte layer 15 or the negative electrode electrolyte layer 25). In FIG. 2, two negative electrodes 20 and one positive electrode 10 are laminated in the lamination direction (in the y direction of FIG. 2), but the numbers of the electrodes in the laminate of the secondary battery 1 are not limited thereto.

<Positive Electrode Collector Foil 13>

An aluminum foil, a perforated foil made of aluminum having a pore diameter of from 0.1 mm to 10 mm, an expanded metal, a foamed aluminum sheet, or the like is used as the positive electrode collector foil 13. As a material thereof, stainless steel, titanium, or the like may be applied other than aluminum. The thickness of the positive electrode collector foil 13 is preferably from 10 nm to 1 mm. The thickness of the positive electrode collector foil 13 is desirably from about 1 μm to about 100 μm from the viewpoint of balancing the energy density of the secondary battery 1 and the mechanical strength of the electrode.

<Positive Electrode Mixture Layer 14>

The positive electrode mixture layer 14 includes at least a positive electrode active material allowing insertion and extraction of lithium. For example, a lithium-containing transition metal oxide, typified by lithium cobalt oxide, lithium nickel oxide, and lithium manganese oxide, or a mixture thereof may be used as the positive electrode active material.

The positive electrode mixture layer 14 may include: a conductive material responsible for electron conductivity in the positive electrode mixture layer 14; a binder for securing adhesiveness between materials in the positive electrode mixture layer 14; and further, an electrolytic solution for securing ion conductivity in the positive electrode mixture layer 14.

For example, polyvinyl fluoride, polyvinylidene fluoride (PVdF), a vinylidene fluoride-hexafluoropropylene copolymer (P(VdF-HFP)), polyethylene oxide (PEO), polypropylene oxide (PPO), polytetrafluoroethylene, polyimide, or a styrene-butadiene rubber, or a mixture thereof may be used for the binder.

The electrolytic solution is not particularly limited as long as the electrolytic solution is anon-aqueous electrolytic solution. For example, a lithium salt, such as lithium bis(trifluoromethanesulfonyl)imide, lithium bis(fluorosulfonyl)imide, lithium hexafluorophosphate, lithium perchlorate, or lithium borofluoride, or a mixture thereof may be used as the electrolyte salt.

In addition, for example, an organic solvent, such as tetraethylene glycol dimethyl ether, triethylene glycol dimethyl ether, ethylene carbonate, dimethyl carbonate, ethyl methyl carbonate, propylene carbonate, diethyl carbonate, 1,2-dimethoxyethane, 1,2-diethoxyethane, γ-butyrolactone, tetrahydrofuran, 1,3-dioxolane, 4-methyl-1,3-dioxolane, diethyl ether, sulfolane, methylsulfolane, acetonitrile, or propionitrile, or a mixed liquid thereof may be used as a solvent of the non-aqueous electrolytic solution.

A solvent which has a high boiling point and is non-volatile is preferred from a safety viewpoint. From such viewpoint, tetraethylene glycol dimethyl ether and triethylene glycol dimethyl ether are particularly preferred.

A method of forming the positive electrode mixture layer 14 includes dissolving materials of the positive electrode mixture layer 14 in a solvent to provide a slurry, and applying the slurry onto the positive electrode collector foil 13. An application method is not particularly limited, and any heretofore known method, such as a doctor blade method, a dipping method, or a spray method, may be utilized. In addition, it is also appropriate to perform application and drying a plurality of times to laminate a plurality of positive electrode mixture layers 14 on the positive electrode collector foil 13. After that, through drying for removal of the solvent and a press step for securing the electron conductivity and the ion conductivity in the positive electrode mixture layer 14, the positive electrode mixture layer 14 is formed.

The thickness of the positive electrode mixture layer 14 is set in accordance with the energy density, rate characteristics, and input-output characteristics of the secondary battery 1, and generally falls within a size of from several micrometers to several hundred micrometers. The particle diameters of the materials of the positive electrode mixture layer 14, such as the positive electrode active material, are each specified to a value equal to or smaller than the thickness of the positive electrode mixture layer 14. When powder of the positive electrode active material contains coarse particles each having a particle diameter equal to or larger than the thickness of the positive electrode mixture layer 14, the coarse particles are removed in advance through sieve classification, wind classification, or the like to prepare particles each having a particle diameter equal to or smaller than the thickness of the positive electrode mixture layer 14.

<Negative Electrode Collector Foil 23>

A copper foil, a perforated foil made of copper having a pore diameter of from 0.1 mm to 10 mm, an expanded metal, a foamed copper sheet, or the like is used as the negative electrode collector foil 23. As a material thereof, stainless steel, titanium, nickel, or the like may be applied other than copper. The thickness of the negative electrode collector foil 23 is preferably from 10 nm to 1 mm. The thickness of the negative electrode collector foil 23 is desirably from about 1 μm to about 100 μm from the viewpoint of balancing the energy density of the secondary battery 1 and the mechanical strength of the electrode.

<Negative Electrode Mixture Layer 24>

The negative electrode mixture layer 24 includes at least a negative electrode active material allowing insertion and extraction of lithium. For example, a material typified by a carbon material, such as hard carbon, soft carbon, or graphite, an oxide, such as silicon oxide, niobium oxide, titanium oxide, tungsten oxide, molybdenum oxide, or lithium titanium oxide, or a material capable of forming an alloy with lithium, such as silicon, tin, germanium, lead, or aluminum, or a mixture thereof may be used as the negative electrode active material.

The negative electrode mixture layer 24 may include: a conductive material responsible for electron conductivity in the negative electrode mixture layer 24; a binder for securing adhesiveness between materials in the negative electrode mixture layer 24; and further, an electrolytic solution for securing ion conductivity in the negative electrode mixture layer 24. For example, polyvinyl fluoride, polyvinylidene fluoride (PVdF), a vinylidene fluoride-hexafluoropropylene copolymer (P(VdF-HFP)), polyethylene oxide (PEO), polypropylene oxide (PPO), polytetrafluoroethylene, polyimide, or a styrene-butadiene rubber, or a mixture thereof may be used as the binder, as in the positive electrode 10. The electrolytic solution is not particularly limited as long as the electrolytic solution is a non-aqueous electrolytic solution, as in the positive electrode mixture layer 14.

A method of forming the negative electrode mixture layer 24 is similar to the method of forming the positive electrode mixture layer 14, and hence a description thereof is omitted. The thickness of the negative electrode mixture layer 24 is set in accordance with the energy density, rate characteristics, and input-output characteristics of the secondary battery 1, and generally falls within a size of from several micrometers to several hundred micrometers. The particle diameters of the materials of the negative electrode mixture layer 24, such as the negative electrode active material, are each specified to a value equal to or smaller than the thickness of the negative electrode mixture layer 24. When powder of the negative electrode active material contains coarse particles each having a particle diameter equal to or larger than the thickness of the negative electrode mixture layer 24, the coarse particles are removed in advance through sieve classification, wind classification, or the like to prepare particles each having a particle diameter equal to or smaller than the thickness of the negative electrode mixture layer 24.

<Positive Electrode Electrolyte Layer 15 and Negative Electrode Electrolyte Layer 25>

The positive electrode electrolyte layer 15 and the negative electrode electrolyte layer 25 each include a semi-solid electrolyte. First, materials of the semi-solid electrolyte are described. The semi-solid electrolyte contains an electrolytic solution and a skeleton material. The electrolytic solution is not particularly limited as long as the electrolytic solution is a non-aqueous electrolytic solution as with the electrolytic solutions in the positive electrode 10 and the negative electrode 20.

The skeleton material, which is configured to adsorb the electrolytic solution, is not particularly limited as long as the skeleton material is a solid without electron conductivity. However, it is desired that the skeleton material have a large particle surface area per unit volume in order to increase the adsorption amount of the electrolytic solution, and hence fine particles are desired. A particle diameter thereof is preferably from several nanometers to several micrometers. As a material thereof, there are given, for example, silicon dioxide, aluminum oxide, titanium dioxide, zirconium oxide, cerium oxide, polypropylene, polyethylene, and a mixture thereof, but the material is not limited thereto.

In addition, each electrolyte layer may include a binder. When the electrolyte layer includes a binder, its strength can be increased. For example, polyvinyl fluoride, polyvinylidene fluoride (PVdF), a vinylidene fluoride-hexafluoropropylene copolymer (P(VdF-HFP)), polyethylene oxide (PEO), polypropylene oxide (PPO), polytetrafluoroethylene, polyimide, or a styrene butadiene rubber, or a mixture thereof may be used as the binder.

<Structure 40>

The structure 40 includes an electrolytic solution and a porous material. The electrolytic solution is not particularly limited as long as the electrolytic solution is a non-aqueous electrolytic solution as with the electrolytic solutions in the positive electrode 10, the negative electrode 20, the positive electrode electrolyte layer 15, and the negative electrode electrolyte layer 25.

The material and form of the porous material are not particularly limited as long as the electrolytic solution can exist in its pores. The porous material contains, for example, inorganic particles and a binder, or a resin sheet. The inorganic particles are not particularly limited as long as the inorganic particles are each a solid without electron conductivity, and for example, silicon dioxide, aluminum oxide, titanium dioxide, zirconium oxide, cerium oxide, polypropylene, or polyethylene, or a mixture thereof may be used.

In addition, for example, polyvinyl fluoride, polyvinylidene fluoride (PVdF), a vinylidene fluoride-hexafluoropropylene copolymer (P(VdF-HFP)), polyethylene oxide (PEO), polypropylene oxide (PPO), polytetrafluoroethylene, polyimide, or a styrene butadiene rubber, or a mixture thereof may be used as the binder, as in the positive electrode electrolyte layer 15 and the negative electrode electrolyte layer 25.

In the resin sheet, for example, sheet materials made of polyolefins, such as polypropylene and polyethylene, may be used.

When the inorganic particles and the binder are used for the porous material, the structure 40 may be formed by using a slurry containing the inorganic particles and the binder, or by using a sheet material containing the inorganic particles and the binder.

In addition, it is desired to use the sheet material for the porous material because the laminate of the secondary battery 1 in this embodiment is obtained by laminating the positive electrode 10 in a sheet form and the negative electrode 20 in a sheet form on each other. When the porous material is formed of the sheet material, the same lamination device as those used for the positive electrode 10 and the negative electrode 20 can be used, and a manufacturing cost can be reduced.

The structure 40 is arranged in a region which is sandwiched between two negative electrode electrolyte layers 25 (insulating layers) and faces at least part of an edge of the positive electrode 10. As described above, the negative electrode 20 is larger than the positive electrode 10 in the in-plane directions, and hence a recessed region is formed by the two negative electrode electrolyte layers 25 and the edge of the positive electrode 10. The structure 40 is arranged in the recessed region.

The secondary battery 1 illustrated in FIG. 2B includes the structure 40 also in a gap between the positive electrode terminal portion 12 and the negative electrode electrolyte layer 25. With this, as also illustrated in FIG. 1, the structure 40 can be arranged in the regions facing the four side edges of the positive electrode 10. The arrangement position of the structure 40 is not limited thereto.

In addition, in order to prevent a shortage of the electrolytic solution in the insulating layer caused by pressurization, the structure 40 includes a material different from those of the positive electrode electrolyte layer 15 and the negative electrode electrolyte layer 25. Specifically, (1) in the case in which the insulating layer has pores, the average pore diameter of the pores of the structure 40 is larger than the average pore diameter of the pores of the insulating layer, or (2) in the case in which the structure 40 is formed through use of the inorganic particles, the average particle diameter of the inorganic particles is larger than the average particle diameter of the skeleton material in the insulating layer, or (3) the particle diameter distribution of the inorganic particles is narrower than the particle diameter distribution of the skeleton material in the insulating layer. The structure 40 in this embodiment has at least one of the above-mentioned three features.

The feature (1) is described. The average pore diameter of the porous material in the structure 40 is larger than the average pore diameters of the skeleton materials constituting the positive electrode electrolyte layer 15 and the negative electrode electrolyte layer 25. If the structure 40 has a small pore diameter, the amount of the electrolytic solution carried in a gap between particles is reduced, with the result that an ability of the structure 40 to supply the electrolytic solution is reduced. Meanwhile, when the structure 40 has a large pore diameter, the amount of the electrolytic solution carried in the gap between particles is increased, with the result that the ability of the structure 40 to supply the electrolytic solution is improved.

For example, when the pore diameters of the skeleton materials constituting the positive electrode electrolyte layer 15 and the negative electrode electrolyte layer 25 are from 0.001 μm to 0.1 μm, the pore diameter of the porous material constituting the structure 40 is desirably set to from 0.1 μm to 1 μm. Herein, the pore diameters each refer to, for example, a mode diameter of fine pores measured by a mercury intrusion method.

The feature (2) is described. In the case in which the structure 40 is formed through use of the inorganic particles, when the average particle diameter of the inorganic particles in the structure 40 is larger than the average particle diameters of the skeleton materials in the positive electrode electrolyte layer 15 and the negative electrode electrolyte layer 25, the amount of the electrolytic solution carried by the structure 40 becomes larger than the amounts of the electrolytic solutions carried by the positive electrode electrolyte layer 15 and the negative electrode electrolyte layer 25. With this, even when a load is applied to the positive electrode electrolyte layer 15 or the negative electrode electrolyte layer 25, the positive electrode electrolyte layer 15 or the negative electrode electrolyte layer 25 is replenished with the electrolytic solution incorporated in the structure 40.

The feature (3) is described. In the case in which the structure 40 is formed through use of the inorganic particles, the particle diameter distribution of the inorganic particles is narrower than the particle diameter distributions of the skeleton materials constituting the positive electrode electrolyte layer 15 and the negative electrode electrolyte layer 25. When the inorganic particles have a wide particle diameter distribution (that is, wide variation in particle diameter), the inorganic particles are packed densely, and hence the amount of the electrolytic solution carried in a gap between the particles is reduced, with the result that the ability of the structure 40 to supply the electrolytic solution is reduced. Meanwhile, when the inorganic particles have a narrow particle diameter distribution (that is, less variation in particle diameter), the inorganic particles are less liable to be packed densely, and hence the amount of the electrolytic solution carried in the gap between the particles is increased, with the result that the ability of the structure 40 to supply the electrolytic solution is improved.

For example, when the particle diameter distributions of the skeleton materials constituting the positive electrode electrolyte layer 15 and the negative electrode electrolyte layer 25 are from 0.05 μm to 10 μm, the particle diameter distribution of the inorganic particles constituting the structure 40 is desirably set to from 0.2 μm to 5 μm. Herein, the particle diameter distributions each refer to, for example, in a cumulative distribution of particles as a function of particle diameter (on a volume basis), a range of a cumulative value from a smaller particle diameter side of from 10% to 90%.

According to this embodiment, in the secondary battery 1, a situation in which a load is concentrated at an end portion of the positive electrode 10 at the time of tight binding can be prevented, and lack of the positive electrode electrolyte layer 15 or the negative electrode electrolyte layer 25 can be prevented. In addition, a shortage of the electrolytic solution in each electrolyte layer caused through the tight binding can be prevented.

### EXAMPLES

Next, Example and Comparative Example of the present invention are described. The present invention is not limited to this Example.

First, a positive electrode slurry was produced by using a positive electrode active material, a conductive material, a binder, and an electrolytic solution. Lithium manganese cobalt nickel composite oxide was used as the positive electrode active material, acetylene black was used as the conductive material, polyvinylidene fluoride (PVdF) was used as the binder, and tetraethylene glycol dimethyl ether containing lithium bis(trifluoromethanesulfonyl)imide was used as the electrolytic solution. The molar ratio between lithium bis(trifluoromethanesulfonyl)imide and tetraethylene glycol dimethyl ether was set to 1:1.

The positive electrode active material, the conductive material, the binder, and the electrolytic solution were mixed at 70 wt %, 7 wt %, 9 wt %, and 14 wt %, respectively, and were dispersed in N-methyl-2-pyrrolidone (NMP). Thus, a positive electrode slurry was produced.

In addition, a stainless-steel collector foil was used as the positive electrode collector foil 13. The positive electrode slurry was applied onto the surface of the positive electrode collector foil 13 with a bar coater, and NMP was dried in a hot air drying furnace at 100° C. Thus, the positive electrode mixture layer 14 was formed.

Next, a negative electrode slurry was produced by using a negative electrode active material, a conductive material, a binder, and an electrolytic solution. Graphite was used as the negative electrode active material, acetylene black was used as the conductive material, polyvinylidene fluoride (PVdF) was used as the binder, and lithium bis(trifluoromethanesulfonyl)imide-containing tetraethylene glycol dimethyl ether was used as the electrolytic solution.

The negative electrode active material, the conductive material, the binder, and the electrolytic solution were mixed at 74 wt %, 2 wt %, 10 wt %, and 14 wt %, respectively, and were dispersed in NMP. Thus, a negative electrode slurry was produced.

In addition, a stainless-steel collector foil was used as the negative electrode collector foil 23. The negative electrode slurry was applied onto the surface of the negative electrode collector foil 23 with a bar coater, and NMP was dried in a hot air drying furnace at 100° C. Thus, the negative electrode mixture layer 24 was formed.

Next, an electrolyte slurry was produced by using a skeleton material, a binder, and an electrolytic solution. Silicon dioxide particles were used as the skeleton material, polyvinylidene fluoride (PVdF) was used as the binder, and tetraethylene glycol dimethyl ether containing lithium bis(trifluoromethanesulfonyl)imide was used as the electrolytic solution. The skeleton material, the binder, and the electrolytic solution were mixed at 70 wt %, 10 wt %, and 20 wt %, respectively, and were dispersed in NMP. Thus, an electrolyte slurry was produced.

The electrolyte slurry was applied onto the positive electrode mixture layer 14 laminated on the positive electrode collector foil 13, and NMP was dried in a hot air drying furnace at 100° C. Thus, the positive electrode electrolyte layer 15 was formed. Similarly, the electrolyte slurry was applied onto the negative electrode mixture layer 24 laminated on the negative electrode collector foil 23, and NMP was dried in a hot air drying furnace at 100° C. Thus, the negative electrode electrolyte layer 25 was formed.

In addition, the structure 40 was produced by using the porous material and the electrolytic solution. A polypropylene sheet having a porosity of 40% was used as the porous material, and tetraethylene glycol dimethyl ether containing lithium bis(trifluoromethanesulfonyl)imide was used as the electrolytic solution.

Next, one sheet of the positive electrode 10, two sheets of the negative electrodes 20, and one sheet of the structure 40 were punched into predetermined sizes, and laminated. After that, the resultant was put in the exterior body 30, followed by sealing. Thus, the secondary battery 1 was produced.

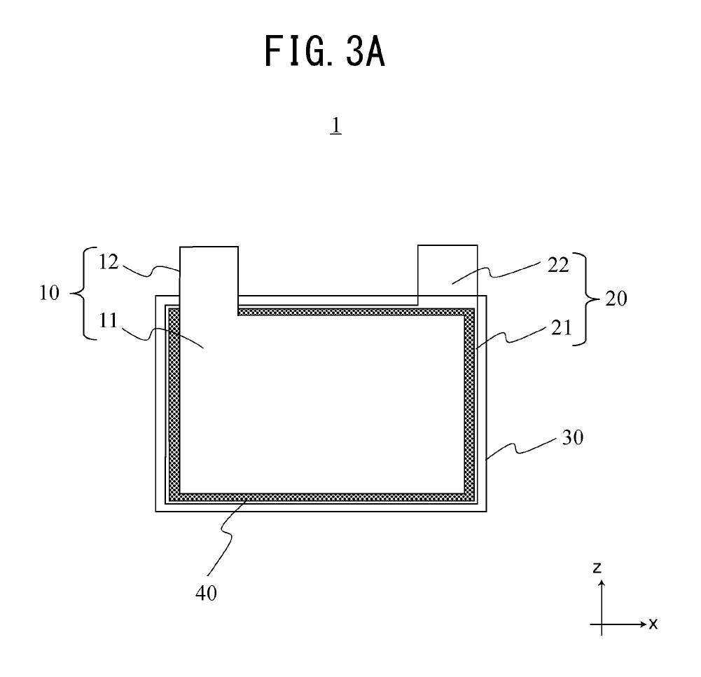

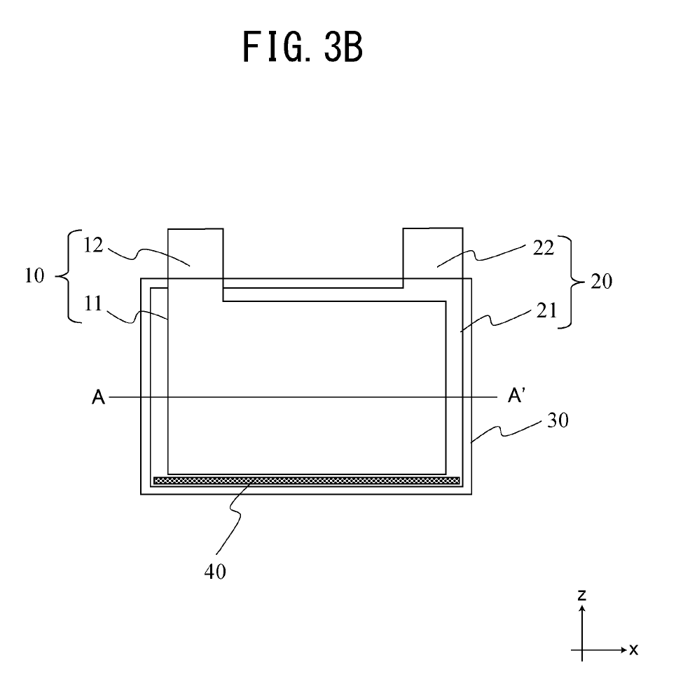

FIG. 3 are views for illustrating arrangement positions of the structures 40 in Example and Comparative Example. The arrangement position of the structure 40 in Example is illustrated in FIG. 3A. In Example, the structure 40 was arranged in regions facing, of four side edges of the positive electrode 10, edges excluding a portion in which the positive electrode terminal portion 12 was formed.

### Comparative Example

The positive electrode 10, the negative electrode 20, and the structure 40 were produced under the same conditions as in Example. The arrangement position of the structure 40 in Comparative Example is illustrated in FIG. 3B. In Comparative Example, the structure 40 was arranged in a region facing a side of the positive electrode 10. Specifically, the structure 40 in Comparative Example was arranged in a region facing a side of the positive electrode 10 in the −z direction of FIG. 3B.

Next, one sheet of the positive electrode 10, two sheets of the negative electrodes 20, and one sheet of the structure 40 were punched into predetermined sizes, and laminated. After that, the resultant was put in the exterior body 30, followed by sealing. Thus, the secondary battery 1 was produced. In order to compare the structures 40 in their ability to supply the electrolytic solution, the structures 40 in Example and Comparative Example have the same total amount of the electrolytic solution per battery.

<Comparison in Short Circuit>

The secondary battery 1 of Comparative Example and the secondary battery 1 of Example were each evaluated for the presence or absence of a short circuit under each of the tight binding conditions (under the three conditions of a load of 0.2 MPa, 0.5 MPa, and 1.0 MPa).

The presence or absence of a short circuit under each of the tight binding conditions is shown in Table 1. When a discharge amount of a first cycle exceeded 80% of a charge amount of the first cycle, it was judged that a short circuit was absent.

TABLE 1

| | Binding load (MPa) | | |
|---|---|---|---|
| | 0.2 | 0.5 | 1.0 |
| Comparative | Short circuit is | Short circuit is | Short circuit is |
| Example | absent | present | present |
| Example | Short circuit is | Short circuit is | Short circuit is |
| | absent | absent | absent |

As shown in Table 1, a short circuit was observed in the secondary battery 1 of Comparative Example in the cases of a load of 0.5 MPa and 1.0 MPa. Accordingly, it was found that a short circuit was less liable to be formed in the secondary battery 1 of Example than in the secondary battery 1 of Comparative Example, in which the structure 40 was formed in a region facing one side edge of the positive electrode 10.

<Comparison in Distribution of Electrolytic Solution>

The secondary batteries 1 of Example and Comparative Example were each tightly bound through application of a load of 1.0 MPa. The batteries after having been tightly bound were each disassembled, and distribution of the electrolytic solution on the surface of the positive electrode electrolyte layer 15 was evaluated as distribution of a weight ratio (S/Si) of sulfur (S) contained in the electrolytic solution to silicon (Si) contained in the skeleton material. An energy dispersive X-ray fluorescence spectrometer (EDX spectrometer) was utilized for the analysis of the weight ratio (S/Si) of sulfur to silicon.

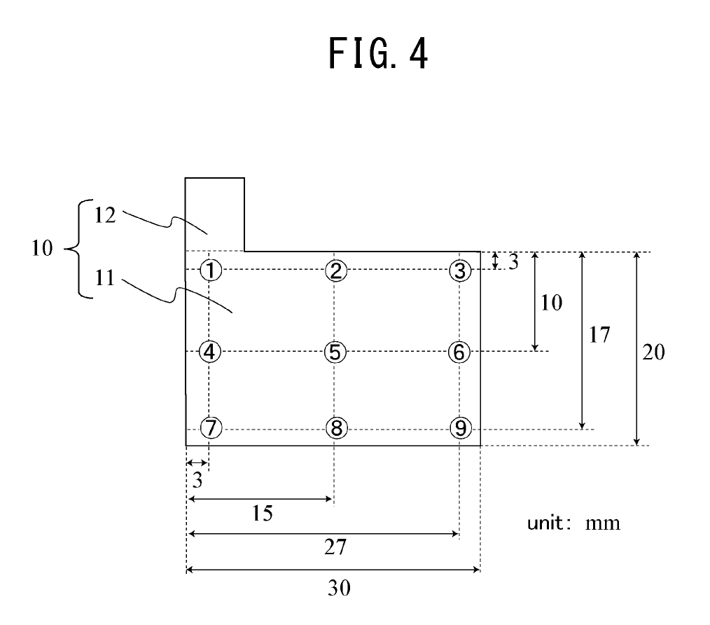

FIG. 4 is a view for illustrating positions subjected to the analysis of the weight ratio (S/Si) of sulfur to silicon. As illustrated in FIG. 4, the electrolytic solution was analyzed at 9 positions on the surface of the positive electrode electrolyte layer 15 (the positive electrode electrolyte layer 15 laminated in an upper direction (in the +y direction) of FIG. 2).

The evaluation results of the distribution of the electrolytic solutions in the secondary batteries 1 of Example and Comparative Example are shown in Table 2. As shown in Table 2, it was found that, when the structure 40 was arranged substantially on four sides of the positive electrode 10, the amount of the electrolytic solution to be supplied to the positive electrode electrolyte layer 15 was increased, and besides, the distribution of the electrolytic solution was uniformized.

TABLE 2

| Analysis | Weight ratio of S/Si | | | | | | | | |
|---|---|---|---|---|---|---|---|---|---|
| position | (1) | (2) | (3) | (4) | (5) | (6) | (7) | (8) | (9) |
| Comparative | 0.21 | 0.19 | 0.21 | 0.22 | 0.22 | 0.22 | 0.24 | 0.24 | 0.24 |
| Example | | | | | | | | | |
| Example | 0.25 | 0.25 | 0.25 | 0.25 | 0.24 | 0.25 | 0.25 | 0.25 | 0.25 |

According to this embodiment, the secondary battery 1 in which lack of the insulating layer is prevented and the insulating layer is improved in its ability to supply the electrolytic solution can be provided. When the amount of the electrolytic solution is increased, the ion conductivity of the electrolyte layer is improved, and hence the charge/discharge characteristics of the secondary battery 1 are improved. In addition, as the distribution of the electrolytic solution is more uniformized, a region short of the electrolytic solution through charge/discharge cycles is less liable to occur, and hence a higher discharge amount is obtained even after the charge/discharge cycles.

The examples and modified examples of the embodiments according to the present invention have been described, but the present invention is not limited to these examples of the embodiments described above and encompasses various modified examples. For example, the examples of the embodiments described above are described in detail for a better understanding of the present invention, and the present invention is not limited to one having the entire configuration described above. In addition, part of the configuration of an example of an embodiment may be replaced with the configuration of another example. In addition, the configuration of an example of an embodiment may be added to the configuration of another example. In addition, for part of the configuration of an example of each embodiment, another configuration may be added, removed, or replaced.

The above-mentioned embodiment is described by taking a lithium ion secondary battery as an example, but the embodiment of the present invention is not limited to the lithium ion secondary battery, and various changes may be made without departing from the gist of the present invention. For example, the present invention is applicable to power storage devices (e.g., other secondary batteries and a capacitor) each including the positive electrode 10, the negative electrode 20, and an insulating layer configured to electrically separate the positive electrode 10 and the negative electrode 20 from each other.

What is claimed is:

1. A secondary battery, comprising:
a negative electrode;
a positive electrode;
an insulating layer; and
a structure having pores each configured to carry an electrolyte, wherein:
the negative electrode and the positive electrode are alternately laminated on each other through intermediation of the insulating layer; and
the structure is arranged in a region which is sandwiched between two of the insulating layers and faces at least part of an edge of the positive electrode, and comprises a material different from a material of the insulating layer.

2. A secondary battery according to claim 1, wherein:
the negative electrode and the positive electrode each have a substantially rectangular shape; and
the structure is arranged in regions facing four side edges of the positive electrode.

3. A secondary battery according to claim 1, wherein the insulating layer comprises an insulating skeleton material and an electrolytic solution containing lithium bis(trifluoromethanesulfonyl)imide and tetraethylene glycol dimethyl ether.

4. A secondary battery according to claim 1, wherein the structure comprises one of inorganic particles and a polyolefin-based resin sheet without electron conductivity.

5. A secondary battery according to claim 1, wherein:
the insulating layer comprises a skeleton material and an electrolytic solution; and
an average pore diameter of the pores of the structure is larger than an average pore diameter of the skeleton material.

6. A secondary battery according to claim 1, wherein:
the insulating layer comprises a skeleton material and an electrolytic solution;
the structure comprises inorganic particles; and
an average particle diameter of the inorganic particles is larger than an average particle diameter of the skeleton material.

7. A secondary battery according to claim 1, wherein:
the insulating layer comprises a skeleton material and an electrolytic solution;
the structure comprises inorganic particles; and
a particle diameter distribution of the inorganic particles is narrower than a particle diameter distribution of the skeleton material.

8. A method of manufacturing a secondary battery, comprising:
alternately laminating a negative electrode and a positive electrode on each other through intermediation of an insulating layer; and
arranging a structure comprising a material different from a material of the insulating layer in a region which is sandwiched between two of the insulating layers and faces at least part of an edge of the positive electrode.
